(19) United States
(12) Patent Application Publication
(10) Pub. No.: US 2023/0108044 A1
(43) Pub. Date: Apr. 6, 2023

(54) APPARATUS AND METHOD OF ENHANCED DEMODULATION REFERENCE SIGNAL (DM-RS) FOR ENHANCED PHYSICAL DOWNLINK CONTROL CHANNEL (PDCCH) TRANSMISSION WITH MULTIPLE BEAMS FROM MULTIPLE TRANSMIT AND RECEIVE POINTS (TRPS)

(71) Applicant: Lenovo (Beijing) Ltd., Beijing (CN)

(72) Inventors: Yi Zhang, Chao Yang District (CN); Chenxi Zhu, Haidian District (CN); Bingchao Liu, Changping District (CN); Wei Ling, Changping (CN)

(73) Assignee: Lenovo (Beijing) Ltd., Beijing (CN)

(21) Appl. No.: 17/793,143

(22) PCT Filed: Jan. 17, 2020
(86) PCT No.: PCT/CN2020/072784

§ 371 Date: Jul. 15, 2022

(51) Int. Cl. H04L 5/00; H04W 72/232; H04W 72/231

(52) U.S. Cl. CPC H04L 5/0053; H04L 5/0051; H04L 5/0091; H04W 72/232; H04W 72/231

(57) ABSTRACT

Apparatus and methods of enhanced DM-RS for enhanced PDCCH transmission with multiple beams from multiple TRPs are disclosed. The apparatus includes: a processor that determines a plurality of activated Transmission Configuration Indication (TCI) states for transmission of a Physical Downlink Control Channel (PDCCH) with Demodulation Reference Signal (DM-RS) in a Control Resource Set (CORESET), using a plurality of wireless transmitting-receiving identities, wherein the CORESET comprises a plurality of transmission units having a predefined granularity; and determines one of the TCI states to be used for each of the transmission units and its corresponding DM-RS, based on a TCI state mapping scheme; and a transmitter that transmits a Media Access Control (MAC) Control Element (CE) for activating each of the TCI states; and transmits the PDCCH over the transmission units and the corresponding DM-RS with the corresponding TCI states as determined by the processor, using the plurality of wireless transmitting-receiving identities.

### FIELD

The subject matter disclosed herein relates generally to wireless communication and more particularly relates to, but not limited to, apparatus and methods of enhanced Demodulation Reference Signal (DM-RS) for enhanced Physical Downlink Control Channel (PDCCH) transmission with multiple beams from multiple Transmit and Receive Points (TRPs).

### BACKGROUND

The following abbreviations and acronyms are herewith defined, at least some of which are referred to within the specification.

Third Generation Partnership Project (3GPP), 5th Generation (5G), New Radio (NR), 5G Node B/generalized Node B (gNB), Long Term Evolution (LTE), LTE Advanced (LTE-A), E-UTRAN Node B/Evolved Node B (eNB), Universal Mobile Telecommunications System (UMTS), Worldwide Interoperability for Microwave Access (WiMAX), Evolved UMTS Terrestrial Radio Access Network (E-UTRAN), Wireless Local Area Networking (WLAN), Orthogonal Frequency Division Multiplexing (OFDM), Single-Carrier Frequency-Division Multiple Access (SC-FDMA), Downlink (DL), Uplink (UL), User Entity/Equipment (UE), Network Equipment (NE), Radio Access Technology (RAT), Receive or Receiver (RX), Transmit or Transmitter (TX), Physical Downlink Control Channel (PDCCH), Physical Downlink Shared Channel (PDSCH), Control Channel Element (CCE), Control Element (CE), Control Resource Set (CORESET), Cyclic redundancy check (CRC), Downlink Control Information (DCI), Frequency Division Multiple Access (FDMA), Identification (ID), Media Access Control (MAC), Multiple Input Multiple Output (MIMO), Multi-User MIMO (MU-MIMO), Physical Resource Block (PRB), Quadrature Phase Shift Keying (QPSK), Resource Block (RB), Resource Elements (RE), Resource-Element Group (REG), Reference Signal (RS), Subcarrier Spacing (SCS), Transmit and Receive Point (TRP), Ultra Reliable Low Latency Communications (URLLC), Frequency Range 1 (FR1), Frequency Range 2 (FR2), Transmission Configuration Indication (TCI), Demodulation Reference Signal (DM-RS), Information Element (IE).

In wireless communication, such as a Third Generation Partnership Project (3GPP) mobile network, a wireless mobile network may provide a seamless wireless communication service to a wireless communication terminal having mobility, i.e. user equipment (UE). The wireless mobile network may be formed of a plurality of base stations and a base station may perform wireless communication with the UEs.

The 5G New Radio (NR) is the latest in the series of 3GPP standards which supports very high data rate with lower latency compared to its predecessor LTE (4G) technology. Two types of frequency range (FR) are defined in 3GPP. Frequency of sub-6 GHz range (from 450 to 6000 MHz) is called FR1 and millimeter wave range (from 24.25 GHz to 52.6 GHz) is called FR2. The 5G NR supports both FR1 and FR2 frequency bands.

Enhancements on multi-TRP/panel transmission including improved reliability and robustness with both ideal and non-ideal backhaul between these TRPs are studied. A TRP is an apparatus to transmit and receive signals, and is controlled by a gNB through the backhaul between the gNB and the TRP. A TRP may also be referred to as a wireless transmitting-receiving identity, or simply an identity.

In current NR system, Physical Downlink Control Channel (PDCCH) is transmitted from a single TRP. Additional transmission resources are introduced in spatial domain by different beams from different TRPs, accordingly enhanced transmission for PDCCH with multiple TRPs is desirable, for example, to increase PDCCH capacity and/or to improve PDCCH robustness. Enhanced PDCCH Demodulation Reference Signal (DM-RS) is accordingly also desirable for the enhanced PDCCH transmission.

### SUMMARY

Apparatus and methods of enhanced DM-RS for enhanced PDCCH transmission with multiple beams from multiple TRPs.

According to a first aspect, there is provided an apparatus, including: a processor that determines a plurality of activated Transmission Configuration Indication (TCI) states for transmission of a Physical Downlink Control Channel (PDCCH) with Demodulation Reference Signal (DM-RS) in a Control Resource Set (CORESET), using a plurality of wireless transmitting-receiving identities, wherein the CORESET comprises a plurality of transmission units having a predefined granularity; and determines one of the TCI states to be used for each of the transmission units and its corresponding DM-RS, based on a TCI state mapping scheme; and a transmitter that transmits a Media Access Control (MAC) Control Element (CE) for activating each of the TCI states; and transmits the PDCCH over the transmission units and the corresponding DM-RS with the corresponding TCI states as determined by the processor, using the plurality of wireless transmitting-receiving identities.

According to a second aspect, there is provided an apparatus, including: a receiver that receives a Media Access Control (MAC) Control Element (CE) for activating a plurality of Transmission Configuration Indication (TCI) states; and receives a Physical Downlink Control Channel (PDCCH) with Demodulation Reference Signal (DM-RS) in a Control Resource Set (CORESET), wherein the CORESET comprises a plurality of transmission units having a predefined granularity, and the PDCCH is received over the transmission units and the DM-RS, and each of the transmission units and its corresponding DM-RS has a corresponding TCI state; and a processor that determines that the PDCCH is transmitted from a transmitting device using a plurality of wireless transmitting-receiving identities; and estimates a channel condition for demodulation of the PDCCH using the received DM-RS and the corresponding TCI state based on a TCI state mapping scheme.

According to a third aspect, there is provided a method, including: determining, by a processor, a plurality of activated Transmission Configuration Indication (TCI) states for transmission of a Physical Downlink Control Channel (PDCCH) with Demodulation Reference Signal (DM-RS) in a Control Resource Set (CORESET), using a plurality of wireless transmitting-receiving identities, wherein the CORESET comprises a plurality of transmission units having a predefined granularity; determining, by the processor, one of the TCI states to be used for each of the transmission units and its corresponding DM-RS, based on a TCI state mapping scheme; transmitting, by a transmitter, a Media Access Control (MAC) Control Element (CE) for activating each of the TCI states; and transmitting, by the transmitter, the PDCCH over the transmission units and the corresponding DM-RS with the corresponding TCI states as determined by the processor, using the plurality of wireless transmitting-receiving identities.

According to a fourth aspect, there is provided a method, including: receiving, by a receiver, a Media Access Control (MAC) Control Element (CE) for activating a plurality of Transmission Configuration Indication (TCI) states; receiving, by the receiver, a Physical Downlink Control Channel (PDCCH) with Demodulation Reference Signal (DM-RS) in a Control Resource Set (CORESET), wherein the CORESET comprises a plurality of transmission units having a predefined granularity, and the PDCCH is received over the transmission units and the DM-RS, and each of the transmission units and its corresponding DM-RS has a corresponding TCI state; determining, by a processor, that the PDCCH is transmitted from a transmitting device using a plurality of wireless transmitting-receiving identities; and estimating, by the processor, a channel condition for demodulation of the PDCCH using the received DM-RS and the corresponding TCI state based on a TCI state mapping scheme.

### BRIEF DESCRIPTION OF THE DRAWINGS

A more particular description of the embodiments will be rendered by reference to specific embodiments illustrated in the appended drawings. Given that these drawings depict only some embodiments and are not therefore considered to be limiting in scope, the embodiments will be described and explained with additional specificity and details through the use of the accompanying drawings, in which:

FIG. 1 is a schematic diagram illustrating a wireless communication system in accordance with some implementations of the present disclosure;

FIG. 2 is a schematic block diagram illustrating components of user equipment (UE) in accordance with some implementations of the present disclosure;

FIG. 3 is a schematic block diagram illustrating components of network equipment (NE) in accordance with some implementations of the present disclosure;

FIG. 4 is a schematic diagram illustrating limited PDCCH resource for high aggregation level UE in the case of small bandwidth configuration;

FIG. 5 is a schematic diagram illustrating an example of PDCCH resource mapping for a single TRP with interleaving;

FIG. 6A is a schematic diagram illustrating an example of TCI State

Indication for UE-specific PDCCH Media Access Control (MAC) Control Element (CE) for a single TRP;

FIG. 6B is a schematic diagram illustrating an example of TCI State Indication for UE-specific PDCCH MAC CE in the case of enhanced PDCCH transmission;

FIG. 6C is a schematic diagram illustrating another example of TCI

State Indication for UE-specific PDCCH MAC CE in the case of enhanced PDCCH transmission;

FIG. 7 is a schematic diagram illustrating an example of determination of PDCCH DM-RS TCI state and DM-RS port index for multiple TRP transmission with Resource Element Group (REG) level spatial division multiplexing (SDM);

FIG. 8 is a schematic diagram illustrating an example of determination of PDCCH DM-RS TCI state and DM-RS port index for multiple TRP transmission with Control Channel Element (CCE) level spatial division multiplexing (SDM);

FIG. 9 is a schematic diagram illustrating an example of determination of PDCCH DM-RS TCI state for multiple TRP transmission with REG bundling group level frequency division multiplexing (FDM);

FIG. 10 is a schematic diagram illustrating an example of determination of PDCCH DM-RS TCI state for multiple TRP transmission CCE level frequency division multiplexing (FDM);

FIG. 11 is a flow chart illustrating steps of transmission of enhanced DM-RS for enhanced PDCCH transmission with multiple beams from multiple TRPs by NE; and

FIG. 12 is a flow chart illustrating steps of reception of enhanced DM-RS for enhanced PDCCH transmission with multiple beams from multiple TRPs by UE.

### DETAILED DESCRIPTION

As will be appreciated by one skilled in the art, aspects of the embodiments may be embodied as a system, an apparatus, a method, or a program product. Accordingly, embodiments may take the form of an all-hardware embodiment, an all-software embodiment (including firmware, resident software, micro-code, etc.) or an embodiment combining software and hardware aspects.

For example, the disclosed embodiments may be implemented as a hardware circuit comprising custom very-large-scale integration (VLSI) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, one or more embodiments may take the form of a program product embodied in one or more computer readable storage devices storing machine readable code, computer readable code, and/or program code, referred to hereafter as “code”. The storage devices may be tangible, non-transitory, and/or non-transmission.

Any combination of one or more computer readable media may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

A non-exhaustive list of more specific examples of the storage device may include the following: an electrical connection having one or more wires, a portable computer diskette, a hard disk, a random-access memory (RAM), a read-only memory (ROM), an erasable programmable read-only memory (EPROM, or Flash memory), a portable Compact Disc Read-Only Memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Reference throughout this specification to “one embodiment,” “an embodiment,” “an example,” “some embodiments,” “some examples,” or similar language means that a particular feature, structure, or characteristic described is included in at least one embodiment or example. Thus, instances of the phrases “in one embodiment,” “in an example,” “in some embodiments,” and similar language throughout this specification may, but do not necessarily, all refer to the same embodiment(s). It may or may not include all the embodiments disclosed. Features, structures, elements, or characteristics described in connection with one or some embodiments are also applicable to other embodiments, unless expressly specified otherwise. The terms “including”, “comprising”, “having”, and variations thereof mean “including but not limited to”, unless expressly specified otherwise.

An enumerated listing of items does not imply that any or all of the items are mutually exclusive, unless expressly specified otherwise. The terms “a”, “an”, and “the” also refer to “one or more” unless expressly specified otherwise.

It should be understood that the term “and/or” as used herein refers to and includes any and all possible combinations of one or more of the associated listed items. For example, “A and/or B” may refer to any one of the following three combinations: existence of A only, existence of B only, and co-existence of both A and B.

The character “/” generally indicates an “or” relationship of the associated items, but may also include an “and” relationship of the associated items. For example, “A/B” means “A or B”, which may also include the co-existence of both A and B, unless the context indicates otherwise.

Throughout the disclosure, the terms “first”, “second”, “third”, and etc.

are all used as nomenclature only for references to relevant devices, components, procedural steps, and etc. without implying any spatial or chronological orders, unless expressly specified otherwise. For example, a “first device” and a “second device” may refer to two separately formed devices, or two parts or components of the same device. In some cases, for example, a “first device” and a “second device” may be identical, and may be named arbitrarily. Similarly, a “first step” of a method or process may be carried or performed after, or simultaneously with, a “second step”.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of various embodiments are described below with reference to schematic flowchart diagrams and/or schematic block diagrams of methods, apparatuses, systems, and program products. It will be understood that each block of the schematic flowchart diagrams and/or schematic block diagrams, as well as combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions executed via the processor of the computer or other programmable data processing apparatus create a means for implementing the functions or acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function or act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code executed on the computer or other programmable apparatus provides processes for implementing the functions or acts specified in the schematic flowchart diagrams and/or schematic block diagram.

The schematic flowchart diagrams and/or schematic block diagrams in the Figures illustrate the architecture, functionality, and operation of possible implementations of different apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s). One skilled in the relevant art will recognize, however, that the flowchart diagrams need not necessarily be practiced in the sequence shown and are able to be practiced without one or more of the specific steps, or with other steps not shown.

It should also be noted that, in some alternative implementations, the functions noted in the identified blocks may occur out of the order noted in the Figures. For example, two blocks shown in succession may, in fact, be substantially executed in concurrence, or the blocks may sometimes be executed in reverse order, depending upon the functionality involved. Other steps and methods may be conceived that are equivalent in function, logic, or effect to one or more blocks, or portions thereof, to the illustrated Figures.

The description of elements in each figure may refer to elements of proceeding figures. Like-numbers refer to like-elements in all figures, including alternate embodiments of like-elements.

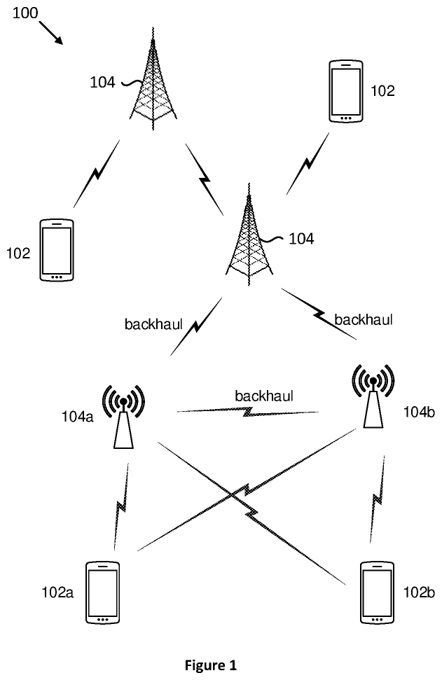

FIG. 1 is a schematic diagram illustrating a wireless communication system. It depicts an embodiment of a wireless communication system 100. In one embodiment, the wireless communication system 100 may include a user equipment (UE) 102 and a network equipment (NE) 104. Even though a specific number of UEs 102 and NEs 104 is depicted in FIG. 1, one skilled in the art will recognize that any number of UEs 102 and NEs 104 may be included in the wireless communication system 100.

The UEs 102 may be referred to as remote devices, remote units, subscriber units, mobiles, mobile stations, users, terminals, mobile terminals, fixed terminals, subscriber stations, user terminals, apparatus, devices, or by other terminology used in the art.

In one embodiment, the UEs 102 may be autonomous sensor devices, alarm devices, actuator devices, remote control devices, or the like. In some other embodiments, the UEs 102 may include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), or the like. In some embodiments, the UEs 102 include wearable devices, such as smart watches, fitness bands, optical head-mounted displays, or the like. The UEs 102 may communicate directly with one or more of the NEs 104.

The NE 104 may also be referred to as a base station, an access point, an access terminal, a base, a Node-B, an eNB, a gNB, a Home Node-B, a relay node, an apparatus, a device, or by any other terminology used in the art. Throughout this specification, a reference to a base station may refer to any one of the above referenced types of the network equipment 104, such as the eNB and the gNB.

The NEs 104 may be distributed over a geographic region. The NE 104 is generally part of a radio access network that includes one or more controllers communicably coupled to one or more corresponding NEs 104. The radio access network is generally communicably coupled to one or more core networks, which may be coupled to other networks, like the Internet and public switched telephone networks. These and other elements of radio access and core networks are not illustrated, but are well known generally by those having ordinary skill in the art.

In one implementation, the wireless communication system 100 is compliant with a 3GPP 5G new radio (NR). In some implementations, the wireless communication system 100 is compliant with a 3GPP protocol, where the NEs 104 transmit using an OFDM modulation scheme on the DL and the UEs 102 transmit on the uplink (UL) using a SC-FDMA scheme or an OFDM scheme. More generally, however, the wireless communication system 100 may implement some other open or proprietary communication protocols, for example, WiMAX. The present disclosure is not intended to be limited to the implementation of any particular wireless communication system architecture or protocol.

The NE 104 may serve a number of UEs 102 within a serving area, for example, a cell (or a cell sector) or more cells via a wireless communication link. The NE 104 transmits DL communication signals to serve the UEs 102 in the time, frequency, and/or spatial domain.

Communication links are provided between the NE 104 and the UEs 102a, 102b, 102c, and 102d, which may be NR UL or DL communication links, for example. Some UEs 102 may simultaneously communicate with different Radio Access Technologies (RATs), such as NR and LTE.

Direct or indirect communication link between two or more NEs 104 may be provided.

The NE 104 may also include one or more transmit receive points (TRPs) 104a. In some embodiments, the network equipment may be a gNB 104 that controls a number of TRPs 104a. In addition, there is a backhaul between two TRPs 104a. In some other embodiments, the network equipment may be a TRP 104a that is controlled by a gNB.

Communication links are provided between the NEs 104, 104a and the UEs 102, 102a, respectively, which, for example, may be NR UL/DL communication links. Some UEs 102, 102a may simultaneously communicate with different Radio Access Technologies (RATs), such as NR and LTE.

In some embodiments, the UE 102a may be able to communicate with two or more TRPs 104a that utilize a non-ideal backhaul, simultaneously. A TRP may be a transmission point of a gNB. Multiple beams may be used by the UE and/or TRP(s). The two or more TRPs may be TRPs of different gNB s, or a same gNB.

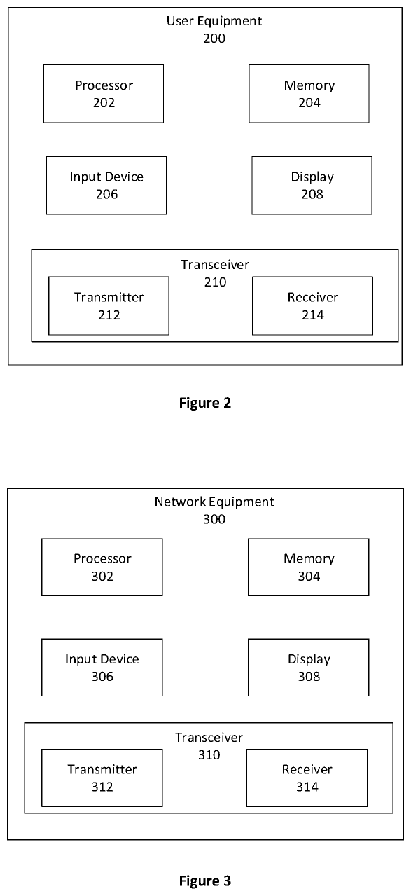

FIG. 2 is a schematic block diagram illustrating components of user equipment (UE) according to one embodiment. A UE 200 may include a processor 202, a memory 204, an input device 206, a display 208, and a transceiver 210. In some embodiments, the input device 206 and the display 208 are combined into a single device, such as a touchscreen. In certain embodiments, the UE 200 may not include any input device 206 and/or display 208. In various embodiments, the UE 200 may include one or more processors 202 and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (CPU), a graphics processing unit (GPU), an auxiliary processing unit, a field programmable gate array (FPGA), or similar programmable controller. In some embodiments, the processor 202 executes instructions stored in the memory 204 to perform the methods and routines described herein. The processor 202 is communicatively coupled to the memory 204 and the transceiver 210.

The memory 204, in one embodiment, is a computer readable storage medium. In some embodiments, the memory 204 includes volatile computer storage media. For example, the memory 204 may include a RAM, including dynamic RAM (DRAM), synchronous dynamic RAM (SDRAM), and/or static RAM (SRAM). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 stores data relating to trigger conditions for transmitting the measurement report to the network equipment. In some embodiments, the memory 204 also stores program code and related data.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audio, and/or haptic signals. In some embodiments, the display 208 includes an electronic display capable of outputting visual data to a user. For example, the display 208 may include, but is not limited to, an LCD display, an LED display, an OLED display, a projector, or a similar display device capable of outputting images, text, or the like to a user. As another non-limiting example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audio alert or notification (e.g., a beep or chime). In some embodiments, the display 208 includes one or more haptic devices for producing vibrations, motion, or other haptic feedback. In some embodiments, all or a portion of the display 208 may be integrated with the input device 206. For example, the input device 206 and the display 208 may form a touchscreen or a similar touch-sensitive display. In other embodiments, the display 208 may be located near the input device 206.

The transceiver 210, in one embodiment, is configured to communicate wirelessly with the network equipment. In certain embodiments, the transceiver 210 comprises a transmitter 212 and a receiver 214. The transmitter 212 is used to transmit UL communication signals to the network equipment and the receiver 214 is used to receive DL communication signals from the network equipment.

The transmitter 212 and the receiver 214 may be any suitable type of transmitters and receivers. Although only one transmitter 212 and one receiver 214 are illustrated, the transceiver 210 may have any suitable number of transmitters 212 and receivers 214. For example, in some embodiments, the UE 200 includes a plurality of the transmitter 212 and the receiver 214 pairs for communicating on a plurality of wireless networks and/or radio frequency bands, with each of the transmitter 212 and the receiver 214 pairs configured to communicate on a different wireless network and/or radio frequency band.

FIG. 3 is a schematic block diagram illustrating components of network equipment (NE) 300 according to one embodiment. The NE 300 may include a processor 302, a memory 304, an input device 306, a display 308, and a transceiver 310. As may be appreciated, in some embodiments, the processor 302, the memory 304, the input device 306, the display 308, and the transceiver 310 may be similar to the processor 202, the memory 204, the input device 206, the display 208, and the transceiver 210 of the UE 200, respectively.

In some embodiments, the processor 302 controls the transceiver 310 to transmit DL signals or data to the UE 200. The processor 302 may also control the transceiver 310 to receive UL signals or data from the UE 200. In another example, the processor 302 may control the transceiver 310 to transmit DL signals containing various configuration data to the UE 200, as described above.

The transceiver 310, in one embodiment, is configured to communicate wirelessly with the UE 200. In certain embodiments, the transceiver 310 comprises a transmitter 312 and a receiver 314. The transmitter 312 is used to transmit DL communication signals to the UE 200 and the receiver 314 is used to receive UL communication signals from the UE 200.

The transceiver 310 may communicate simultaneously with a plurality of UEs 200. For example, the transmitter 312 may transmit DL communication signals to the UE 200. As another example, the receiver 314 may simultaneously receive UL communication signals from the UE 200. The transmitter 312 and the receiver 314 may be any suitable type of transmitters and receivers. Although only one transmitter 312 and one receiver 314 are illustrated, the transceiver 310 may have any suitable number of transmitters 312 and receivers 314. For example, the NE 300 may serve multiple cells and/or cell sectors, where the transceiver 310 includes a transmitter 312 and a receiver 314 for each cell or cell sector.

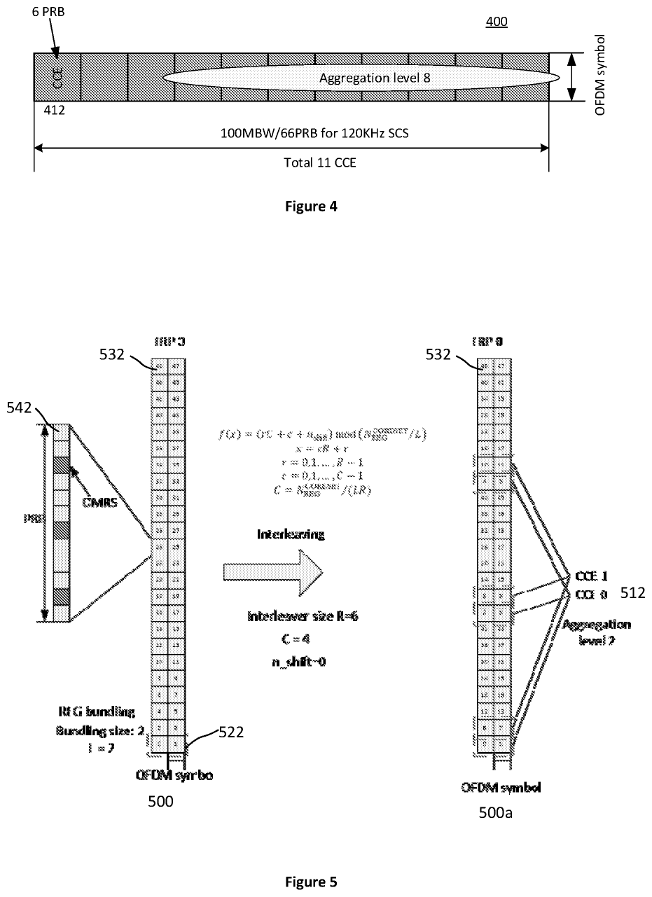

FIG. 4 is a schematic diagram illustrating limited PDCCH resource for high aggregation level UE in the case of small bandwidth configuration in accordance with some implementations of the present disclosure. In the current NR system, Physical Downlink Control Channel (PDCCH) is transmitted from a single transceiver point or transmit and receive point (TRP). PDCCH capacity is limited for the case of small bandwidth configuration or more scheduled users by Multi-user Multiple Input Multiple Output (MU-MIMO). As shown in FIG. 4, which is one example of a typical PDCCH configuration for FR2, a control resource set (CORESET) 400 has eleven (11) CCEs 412 in one OFDM symbol for 100M bandwidth and 120K subcarrier spacing (SCS), which is able to support aggregation level 8 UE. This is not able to support aggregation level 16 UE with the CORESET 400 of one OFDM symbol. That is, the PDCCH resource is insufficient for aggregation level 16 UE because there are only 11 CCEs. In addition, the reliability of PDCCH may be further enhanced for Ultra Reliable Low Latency Communications (URLLC) scenario, where enhancement for Physical Downlink Shared Channel (PDSCH) has already been made with multiple TRP transmission.

Enhanced transmission for PDCCH with multiple TRPs is a topic for Release 17 enhanced MIMO work item. The PDCCH can be transmitted on time-frequency resource from multiple TRPs with many candidates, such as from multiple TRPs simultaneously by spatial division multiplexing or from alternate TRPs by frequency division multiplexing/time division multiplexing. For these schemes, there are several problems based on available PDCCH DM-RS designed in Release 15. Firstly, multiple activated PDCCH DM-RS TCI states are required for enhanced PDCCH transmission with multiple TRPs, whereas only one TCI state may be activated for PDCCH DM-RS in the current specification. Secondly, the TCI state for PDCCH DM-RS may change according to the transmitted beam/TRP for enhanced PDCCH transmission with multiple TRPs. Thus, it needs to specify on how to determine the TCI state for alignment of the behaviour between gNB and UE. Thirdly, the interference between different PDCCH DM-RS ports from different beams may be randomized with different DM-RS sequences and thus improving demodulation performance. In release 15, only CORESET specific PDCCH scrambling ID is configured and thus the same scrambling sequence may be used for different ports of PDCCH DM-RS according to the current specification. Further, orthogonal DM-RS may be used to reduce interference between different ports with different beams and thus improve demodulation performance.

FIG. 5 is a schematic diagram illustrating an example of PDCCH resource mapping for a single TRP with interleaving in accordance with some implementations of the present disclosure. In Release 15, elaborate resource mapping scheme is specified for PDCCH. In detail, for one UE, it can be configured with multiple Control Resource Sets (CORESETs), where each control resource set consists of N_{RB}^{CORESET} resource blocks in the frequency domain and N_{symb}^{CORESET}∈{1,2,3} symbols in the time domain. Transmission resources in one CORESET 500 are split into multiple Resource Element Groups (REGs) 532, each of which equals to one resource block (RB, or PRB) within one OFDM symbol. An REG or PRB further consists of 12 Resource Elements (REs) 542. The REGs 532 within a CORESET are numbered in increasing order firstly in the time domain then in the frequency domain. Six REGs form a Control Channel Element (CCE) 512, and one or more CCEs could be aggregated for one PDCCH transmission. The supported aggregation level is shown in Table 1 below.

TABLE 1
Supported PDCCH aggregation levels.

| Aggregation level | Number of CCEs |
|---|---|
| 1 | 1 |
| 2 | 2 |
| 4 | 4 |
| 8 | 8 |
| 16 | 16 |

As shown in FIG. 5, the CORESET 500 consists of 24 PRBs and 2 OFDM symbols. There are totally 48 REGs 532 in this CORESET. One PDCCH with aggregation level 2 uses 2 CCEs 512 for transmission, where each CCE 512 consists of 6 REGs 532. In this mapping scheme, only time-frequency two-dimension resource mapping is specified. It cannot support PDCCH transmission from multiple TRPs, and thus resource mapping for spatial domain, e.g., resource mapping for different beams/TRPs, is not specified.

Each CORESET may be associated with one CCE-to-REG mapping only. It may be in an interleaved or a non-interleaved mode. When the interleaved mode is configured, as shown in FIG. 5, REGs 532 of the interleaved CORESET 500a are interleaved with row-column interleaver based on the interleave size defined by a high layer configured value interleaverSize. The granularity for interleaving unit is one REG bundle 522, which may also be named as REG bundling group, where the bundling size is defined by a higher layer configured value reg-BundleSize. In this disclosure, the terms “REG bundle” and “REG bundling group” may be used interchangeably but with the same meaning.

In the example shown in FIG. 5, the REG bundling size, i.e. L, is 2 and the interleaver size is, i.e. R, is 6. Thus, one CCE consists of 6 REGs which are from 3 interleaved REG bundling groups. In detail, CCE 0 consists of interleaved REG bundling groups that are formed by REGs {0, 1}, {2, 3}, and {4, 5}. CCE 1 consists of interleaved REG bundling groups that are formed by REGs {6, 7}, {8, 9}, and {10, 11}. Other values of REG bundling size L and interleaver size R are also possible. For example, L may also be 3 or 6.

When the non-interleaved mode is configured, the REGs are not interleaved and the REG bundling size is fixed as 6. Interleaving is well designed in time-frequency domain in Release 15. At least some of the proposed resource mapping schemes are compatible with this two-dimension interleaving scheme.

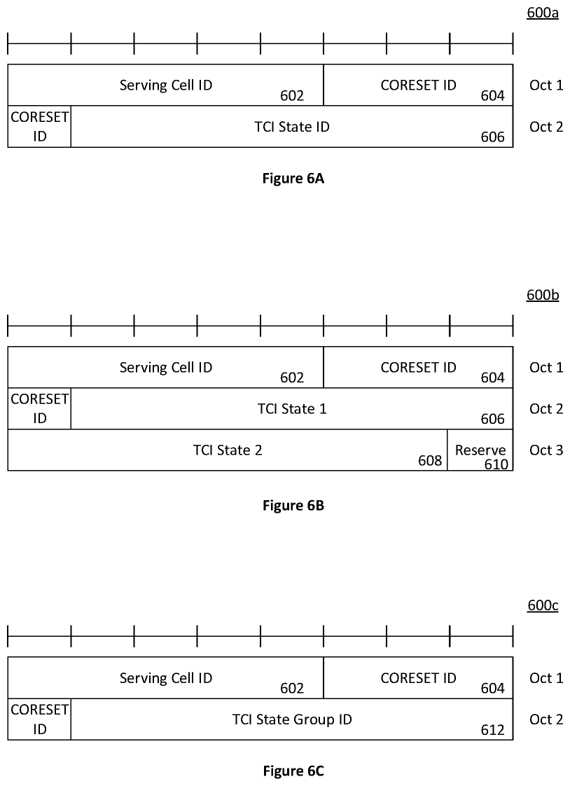

FIG. 6A is a schematic diagram illustrating an example of TCI State Indication for UE-specific PDCCH Media Access Control (MAC) Control Element (CE) for a single TRP. In Release 15, for a CORESET, a list of TCI-State is configured as candidates for indicating quasi co-location information of the DM-RS port for PDCCH reception. The network may indicate a TCI state for PDCCH reception for a CORESET of a serving cell by sending the TCI state indication for UE-specific PDCCH MAC CE. Then, the MAC entity indicates to lower layers the information regarding the TCI state indication for UE-specific PDCCH MAC CE. The detailed information for this UE-specific PDCCH MAC CE 600a is shown in FIG. 6A. In this example, the PDCCH MAC CE 600a includes a Severing Cell ID 602 of 5 bits, a CORSET ID 604 of 4 bits, a TCI State ID 606 of 7 bits. Only one TCI state ID is indicated for quasi co-location information of the DM-RS port for PDCCH reception. It cannot provide enough TCI information in the case of multiple beam/TRP transmission, where information of multiple TCI states is required. Furthermore, the actual TCI state may change during one PDCCH transmission according to the transmit beam/TRP. Determination of TCI states needs to be considered for the enhanced PDCCH DM-RS design.

In 3GPP Release 15 specification, the DM-RS sequence for PDCCH on OFDM symbol l is defined by

$${r}_{l} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) )$$

where the pseudo-random sequence generator for c(i) shall be initialized with

cᵢₙᵢₜ=(2¹⁷(N_{symb}^{slot}n_{s,f}^{μ}+l+1)(2N_{ID}+1)+2N_{ID})mod2³¹

where l is the OFDM symbol number within the slot, n_{s.f}^{μ} is the slot number within a frame, and
N_{ID}∈{0,1, . . . , 65535} is given by the higher-layer parameter pdcch-DMRS-ScramblingID if provided
N_{ID}=N_{ID}^{cell} otherwise.

The PDCCH DM-RS is scrambling by a CORESET specific higher-layer parameter pdcch-DMRS-ScramblinglD (i.e. N_{ID} or N_ID), which is defined in RRC signaling for ControlResourceSet. If different ports of PDCCH DM-RS are from the same CORESET, the same DM-RS sequence is used for different ports. This is not optimal from view of randomizing interference, and may have impact on DM-RS demodulation performance.

An example of the related Radio Resource Control (RRC) signaling may be provided as follows:

| | |
|---|---|
| -- ASN1START | |
| -- TAG-CONTROLRESOURCESET-START | |
| ControlResourceSet ::= | SEQUENCE { |
| controlResourceSetId | ControlResourceSetId, |
| frequencyDomainResources | BIT STRING (SIZE (45)), |
| duration | INTEGER (1..maxCoReSetDuration), |
| cce-REG-MappingType | CHOICE { |
| interleaved | SEQUENCE { |
| reg-BundleSize | ENUMERATED {n2, n3, n6}, |
| interleaverSize | ENUMERATED {n2, n3, n6}, |
| shiftIndex | |
| INTEGER(0..maxNrofPhysicalResourceBlocks-1) | OPTIONAL -- Need S |
| }, | |
| nonInterleaved | NULL |
| }, | |
| precoderGranularity | ENUMERATED {sameAsREG-bundle, |
| allContiguousRBs}, | |
| tci-StatesPDCCH-ToAddList | SEQUENCE(SIZE (1..maxNrofTCI-StatesPDCCH)) |
| OF TCI-StateId OPTIONAL, -- Cond NotSIB1-initialBWP | |
| tci-StatesPDCCH-ToReleaseList | SEQUENCE(SIZE (1..maxNrofTCI-StatesPDCCH)) |
| OF TCI-StateId OPTIONAL, -- Cond NotSIB1-initialBWP | |
| tci-PresentInDCI | ENUMERATED {enabled} |
| OPTIONAL, -- Need S | |
| pdcch-DMRS-ScramblingID | INTEGER (0..65535) |
| OPTIONAL, -- Need S | |
| ... | |
| } | |
| -- TAG-CONTROLRESOURCESET-STOP | |
| -- ASN1STOP | |

The Information Element (IE) ControlResourceSet is used to configure a time/frequency Control Resource Set (CORESET) in which downlink control information (DCI) is searched. Detailed descriptions of the fields in the ControlResourceSet may be found in 3GPP specification TS 38.331. For example, Resource Element Groups (REGs) can be bundled to create REG bundles. The parameter reg-BundleSize defines the size of such bundles.

For PDCCH transmission with multiple TRPs, it needs support from UE capability. In detail, for FR2, multiple panels at the UE side are required to receive the enhanced PDCCHs transmitted with different beams from multiple TRPs. For FR1, multiple receivers are also required to receive the enhanced PDCCHs transmitted with different beams from multiple TRPs. Furthermore, the UE may switch off some panels according to its requirement, e.g., power saving. A gNB needs to decide whether to activate the proposed PDCCH transmission scheme according to the actual conditions, such as the UE's capability and requirement, actual channel condition from multiple candidate beams. Thus, a particular mechanism is required for activation of enhanced PDCCH transmission, where implicit activation scheme may be used on account of low signaling overhead.

An implicit rule may be defined to determine PDCCH DM-RS TCI state for enhanced PDCCH transmission, where the TCI state is associated with transmit beam/TRP based on a corresponding transmit unit (or transmission unit, which may be used interchangeably in this disclosure). The transmit unit may be CCE or REG bundling group or REG. Furthermore, N_ID for PDCCH scrambling is extended to multiple values to randomize interference between DM-RS ports from different beams/TRPs, where each value is linked with one activated TCI state and used for determining an initial sequence for PDCCH DM-RS transmitted from the linked beam/TRP. With some of the examples in the disclosure, accurate demodulation may be made for PDCCH transmission with multiple beams/TRPs for more diversity gain. The same behavior on multiple beam transmission is achieved at both gNB and UE sides based on implicit determining principle for determining the TCI state. There is no additional signaling overhead. In addition, better performance is achieved by interference randomization with different sequences for PDCCH DM-RS transmitted from different TRPs/beams.

One common step for some of the embodiments is activating multiple TCI states for multiple TRP/beam transmission. Two or more TCI states are required to be activated to indicate quasi co-location information of the DM-RS port for PDCCH reception. In one example, two or more TCI states are indicated one by one for UE-specific PDCCH MAC CE, which may be easily extended from available PDCCH DM-RS TCI indication MAC CE. Moreover, the list of TCI-State for activation of multiple TCI states may be different since the TCI states are linked with different beams or candidate beams from different TRPs.

FIG. 6B is a schematic diagram illustrating an example of TCI State Indication for UE-specific PDCCH MAC CE in the case of enhanced PDCCH transmission. In the example as shown in FIG. 6B, the PDCCH MAC CE 600b includes a Severing Cell ID 602 of 5 bits, a CORSET ID 604 of 4 bits, two TCI State IDs 606 and 608 each of 7 bits, and a Reserved bit 610. The TCI state 1 606 and TCI state 2 608 are used to indicate TCI for enhanced PDCCH transmission from two TRPs. In this example, TCI state 1 may be from PDCCH tci-State list 1; while TCI state 2 may be from PDCCH tci-State list 2, and tci-State list 1 and tci-State list 2 may be the same list or different lists. This example may be suitable for cases with a small number of activated TCI states.

FIG. 6C is a schematic diagram illustrating another example of TCI State Indication for UE-specific PDCCH MAC CE in the case of enhanced PDCCH transmission. In the example as shown in FIG. 6C, a TCI state group ID 612, which may be an index to a group consisting of multiple TCI states, may be used for PDCCH DM-RS TCI indication in the PDCCH MAC CE 600c. The TCI state group 612 may be activated by one MAC CE from a set of candidate TCI state lists configured by RRC. A TCI state group, e.g. TCI state group 1, may be selected from a set of TCI state lists configured by RRC signaling. This example may be suitable for cases with a large number of activated TCI states.

Implicit determination of PDCCH DM-RS TCI state, DM-RS port index and DM-RS signal for multiple TRP transmission with spatial division multiplexing

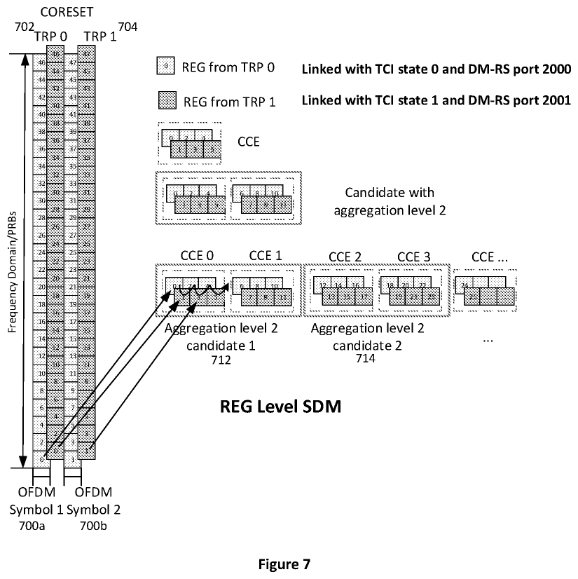

FIG. 7 is a schematic diagram illustrating an example of determination of PDCCH DM-RS TCI state and DM-RS port index for multiple TRP transmission with Resource Element Group (REG) level spatial division multiplexing (SDM).

As shown in FIG. 7, the CORESET includes a first set of resources 702 for transmission from TRP 0, and a second set of resources 704 for transmission from TRP 1. Each set of resources includes a plurality of REGs, 48 in this example, in two OFDM symbols 700a and 700b. Each REG may be associated with an identification number, or an REG ID, ranging from 0 to 47. This REG ID may be referred to as a local index of the REGs. Since there are two sets of REGs, one from each of the TRPs, there are 96 (48×2) REGs in total. A global index of the REGs may be defined, ranging from 0 to 95. In the example as shown in FIG. 7, REG from TRP 0 having local index 0 may be mapped to global index 0; REG from TRP 1 having local index 0 may be mapped to global index 1; REG from TRP 0 having local index 1 may be mapped to global index 2; REG from TRP 1 having local index 1 may be mapped to global index 3; and etc.

Each CCE may include six REGs and may be associated with a further identification number, or a CCE ID. Some examples of the CCEs are shown as CCE 0, CCE 1, CCE 2, and etc. In this example, a CCE may include REGs from both TRPs, for example three REGs from each TRP. Based on an aggregation level, a preset number of CCEs may be grouped together to form a resource candidate. In this example, the aggregation level is two, and thus each resource candidate includes two CCEs. For example, the resource candidate 1 712 comprises CCE 0 and CCE 1; and the resource candidate 2 714 comprises CCE 2, and CCE 3. The CCE ID indicates CCEs from both TRPs and may thus referred to as a global index of the CCEs.

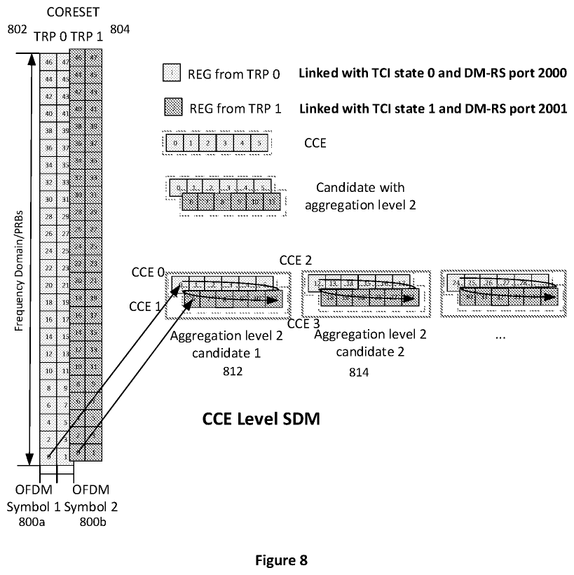

FIG. 8 is a schematic diagram illustrating an example of determination of PDCCH DM-RS TCI state and DM-RS port index for multiple TRP transmission with Control Channel Element (CCE) level spatial division multiplexing (SDM).

As shown in FIG. 8, the CORESET includes a first set of resources 802 for transmission from TRP 0, and a second set of resources 804 for transmission from TRP 1. Each set of resources includes a plurality of REGs, 48 in this example, in two OFDM symbols 800a and 800b. Each REG may be associated with an identification number, or an REG ID, ranging from 0 to 47.

Each CCE may include six REGs and may be associated with a further identification number, or a CCE ID. In this example, a CCE may only include REGs from one TRP. Some examples of the CCEs are shown as CCE 0, CCE 1, CCE 2, and etc. For example, CCE 0 includes six REGs 0 to 5 from TRP 0, while CCE 1 includes six REGs 0 to 5 from TRP 1. Based on an aggregation level, a preset number of CCEs may be grouped together to form a resource candidate. In this example, the aggregation level is two, and thus each resource candidate includes two CCEs. For example, the resource candidate 1 812 comprises CCE 0 and CCE 1; and the resource candidate 2 814 comprises CCE 2, and CCE 3.

Alternatively, resource mapping can be made with extension for basic unit as REG bundling, or REG bundles. That is, REG bundles may be a predefined granularity of the transmission units. In that case, A CCE may consist of REG bundling units, i.e. one or more REG bundles, from multiple TRPs.

To exploit time-frequency resources from multiple beams/TRPs, spatial division multiplexing can be used for enhanced PDCCH transmission. The resource mapping may be extended to spatial resources for transmit unit with different granularities, which may be REG, or REG bundling group, or CCE. To exploit more diversity in spatial, time and frequency domain, the transmit units are concatenated with firstly increasing order of a transmit unit by a beam/TRP followed by other beam(s)/TRP(s). Based on this property, the TCI states of PDCCH DM-RS alternate according to the beam/TRP used for each transmit unit. An REG, REG bundling group or CCE from one TRP is linked with one specific TCI state, and thus its TCI state may be implicitly determined, e.g., by a TCI state mapping scheme. In detail, the TCI state mapping scheme may be expressed as:

k=i mod N

where
k is a TCI state index for PRB(s) in an REG, REG bundling group, or CCE;
i is a global index of the REG, REG bundling group, or CCE;
N is a total quantity (number) of activated TCI states; and
mod is modulo operation.

That is, the index of a TCI state for a transmit unit is a remainder after division of an index of the transmit unit by the quantity of the activated TCI states.

In the examples as shown in FIGS. 7 and 8, with 2 activated TCI states for 2 TRPs, the TCI state of PDCCH DM-RS for PRB(s) in an REG or CCE may be implicitly determined, for example, by alternately using TCI state 0 and TCI state 1, according to the global index of the REG or CCE.

Since spatial multiplexing is used, one DM-RS port is linked with one TCI state, e.g., DM-RS port 2000 is linked with activated TCI state 0 and DM-RS port 2001 is linked with activated TCI state 1 for PDCCH transmission from two TRPs. Similar as the implicit principle for determining TCI state, a DM-RS port index may also be implicitly determined according to the global index of the REG, REG bundling group or CCE, i.e., by a port mapping scheme. In detail, the port mapping scheme may be expressed as:

p=2000+i mod N
where
p is a DM-RS port index for PRB(s) in an REG, REG bundling group, or CCE;
i is a global index of the REG, REG bundling group, or CCE;
N is a total quantity (number) activated TCI states; and
mod is modulo operation.

That is, the DM-RS port index for resources in a transmit unit is 2000 plus a remainder after division of an index of the transmit unit by a quantity of the activated TCI states.

To improve channel estimation quality and demodulation performance, orthogonal or quasi-orthogonal DM-RS may be used.

For orthogonal DM-RS port, different OCCs (orthogonal cover codes) may be used for different DM-RS ports on top of the available RE (resource element) in one PRB. The same DM-RS sequence is applied to all the DM-RS ports. Based on TS 38.211 specification, there are 3 available REs with 1/4 density in one REG for PDCCH DM-RS. An example for the sequence of OCC is shown in Table 2 below, which may be used for DM-RS with maximum 3 orthogonal layers.

TABLE 2
Sequence of OCC for PDCCH DM-RS

| OCC index for DM-RS | Orthogonal cover code |
|---|---|
| 0 | [1 1 1] |
| 1 | [1 e^{j2π/3} e^{j4π/3}] |
| 2 | [1 e^{j4π/3} e^{j2π/3}] |

Each OCC is linked with one DM-RS port. In detail, if TCI state 0 or TCI state 1 is used for PDCCH DM-RS port 2000 or port 2001 where enhanced PDCCH is transmitted from beam/TRP 0 or beam/TRP 1, OCC 0 or OCC 1 will be used to make orthogonal covering for transmitted DM-RS sequence for DM-RS REs in one REG during physical resource mapping, respectively. At the UE side, similar linkage between the DM-RS OCC sequence and the TCI state or DM-RS port is assumed. It is used to make decovering during physical resource demapping for transmitted DM-RS sequence to make channel estimation for demodulation.

For quasi-orthogonal DM-RS port, different DM-RS sequences may be used for different DM-RS ports with SDM to support interference randomization between DM-RS ports with different beams from different TRPs. Thus, multiple DM-RS scrambling IDs may be configured for each CORESET, where each DM-RS scrambling ID is implicitly associated with one DM-RS port. In detail, if TCI state 0 or TCI state 1 is used for PDCCH DM-RS port 2000 or port 2001 where enhanced PDCCH is transmitted from beam/TRP 0 or beam/TRP 1, DM-RS scrambling ID 0 or DM-RS scrambling ID 1 will be used to obtain an initial value for generating the sequence, respectively. At the UE side, similar association between the DM-RS scrambling ID and the TCI state is assumed. It is used to determine scrambling ID for generating DM-RS sequence to make channel estimation for demodulation.

Implicit PDCCH DM-RS TCI State Determination for Multiple TRP Transmission with Frequency Division Multiplexing

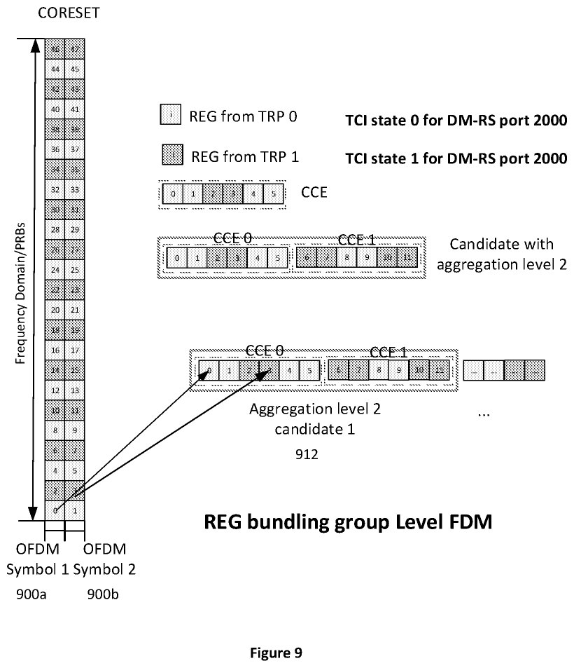

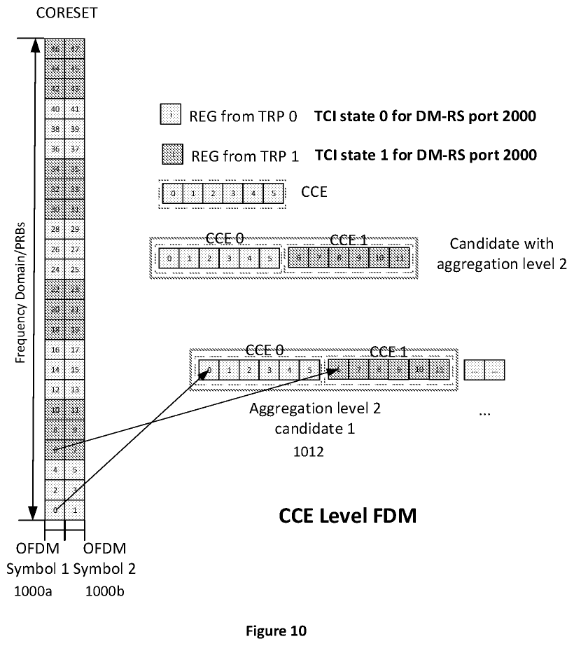

FIG. 9 is a schematic diagram illustrating an example of determination of PDCCH DM-RS TCI state for multiple TRP transmission with REG bundling group level frequency division multiplexing (FDM); and FIG. 10 is a schematic diagram illustrating an example of determination of PDCCH DM-RS TCI state for multiple TRP transmission with Control Channel Element (CCE) level frequency division multiplexing (FDM).

To exploit time-frequency resources from multiple beam/TRPs, frequency division multiplexing may be used for enhanced PDCCH transmission for better robustness. To exploit more diversity in spatial, time and frequency domain, multiple beams may be used alternately for the transmit units in the frequency domain. The transmit unit may have different granularities, e.g. REG bundling group or CCE. Based on this property, the TCI states of PDCCH DM-RS may alternate according to the beam/TRP used for each transmit unit. An REG bundling group or CCE from one TRP is linked with one specific TCI state, and thus its TCI state may be implicitly determined. In detail, the TCI state mapping scheme may be expressed as:

k=i mod N
where
k is a TCI state index for PRBs in an REG bundling group/CCE;
i is a global index of the REG bundling group/CCE;
N is a total activated TCI state number; and
mod is modulo operation.

In some examples, as shown in FIGS. 9 and 10, the TCI state of PDCCH DM-RS for PRB in an REG bundling group or CCE may be implicitly determined, i.e., using TCI state 0 and TCI state 1 alternately, according to the global index of the REG bundling group or CCE. Since only one beam is used for transmission on one PRB although the transmit beam may be different for different PRBs, only DM-RS port 2000 is used with different TCI states for different PRB s. In these examples, a DM-RS sequence similar to that of the Release 15 may apply in the frequency domain irrespective of the TCI state used.

In the example shown in FIG. 9, the CORESET includes a set of resources from two TRPs, i.e., TRP 0 and TRP 1, arranged in an alternative manner based on REG bundles or REG bundling group. The resources include a plurality of REGs in two OFDM symbols 900a and 900b. A resource candidate 1 912 may comprise two CCEs, i.e., CCE 0 and CCE 1. Each CCE may comprise REGs from the two different TRPs. For example, CCE 0 includes REG 0, REG 1, REG 4, and REG 5 from TRP 0, as well as REG 2 and REG 3 from TRP 1; and CCE 1 includes REG 6, REG 7, REG 10, and REG 11 from TRP 1, as well as REG 8 and REG 9 from TRP 0.

In the example shown in FIG. 10, the CORESET includes a set of resources from two TRPs, i.e., TRP 0 and TRP 1, arranged in an alternative manner based on CCE. The resources include a plurality of REGs in two OFDM symbols 1000a and 1000b. A resource candidate 1 1012 may comprise two CCEs, i.e., CCE 0 and CCE 1. Each CCE may consist of REGs from one single TRP. For example, CCE 0 includes REG 0 to REG 5, all of which are from TRP 0; and CCE 1 includes REG 6 to REG 11, all of which are from TRP 1.

For FDM based enhanced PDCCH transmission from multiple TRPs, one sequence may be used for DM-RS on all PRBs, irrespective of which TRP they are from. Alternatively, separate sequences may be used for DM-RS on PRBs from different beams/TRPs. In such case, a DM-RS sequence generation scheme, similar to the abovementioned SDM related sequence generation scheme with multiple configured PDCCH DM-RS scrambling IDs in which one scrambling ID is linked with one TCI state, may be used.

FIG. 11 is a flow chart illustrating steps of transmission of enhanced DM-RS for enhanced PDCCH transmission with multiple beams from multiple TRPs by NE in accordance with some implementations of the present disclosure.

At step 1102, the processor 302 of the NE 300 determines a plurality of activated Transmission Configuration Indication (TCI) states for transmission of a Physical Downlink Control Channel (PDCCH) with Demodulation Reference Signal (DM-RS) in a Control Resource Set (CORESET), using a plurality of wireless transmitting-receiving identities (i.e., TRPs), wherein the CORESET comprises a plurality of transmission units having a predefined granularity.

The predefined granularity may be of Resource Element Group (REG), REG bundle, and/or Control Channel Element (CCE).

At step 1104, the processor 302 further determines one of the TCI states to be used for each of the transmission units and its corresponding DM-RS, based on a TCI state mapping scheme.

At step 1106, the transmitter 314 transmits a Media Access Control (MAC) Control Element (CE) for activating each of the TCI states.

At step 1106, the transmitter 314 further transmits the PDCCH over the transmission units and the corresponding DM-RS with the corresponding TCI states as determined by the processor, using the plurality of wireless transmitting-receiving identities, e.g., TRP 0 and TRP 1.

In some embodiments, the TCI state mapping scheme maps the activated TCI states to the transmission units according to indexes of the transmit units and a quantity of the activated TCI states. The TCI state mapping scheme may be predefined between a transmitting device (e.g., the NE 300) including the processor 302 and a receiving device 200, such that the receiving device 200 is capable of implicitly derive a TCI state for the DM-RS. The TCI state mapping scheme may comprise deriving an index of a TCI state for a transmission unit, that is a remainder after division of an index of the transmission unit by the quantity of the activated TCI states

In some embodiments, the processor 302 further determines a plurality of DM-RS ports for the PDCCH DM-RS based on a port mapping scheme. The port mapping scheme may be predefined between a transmitting device 300 including the processor 302 and a receiving device 200, such that the receiving device 200 is capable of implicitly derive a DM-RS port. The ports mapping scheme may comprise deriving a DM-RS port index for resources in a transmission unit, that is 2000 plus a remainder after division of an index of the transmission unit by a quantity of the activated TCI states.

In some embodiments, the processor 302 further generates a plurality of PDCCH DM-RS scrambling IDs, and each PDCCH DM-RS scrambling ID is associated one TCI state or the DM-RS port, and is used to generate a PDCCH DM-RS sequence. A plurality of Orthogonal Cover Codes (OCCs) may be used for the DM-RS ports, and each OCC is associated with one TCI state or DM-RS port

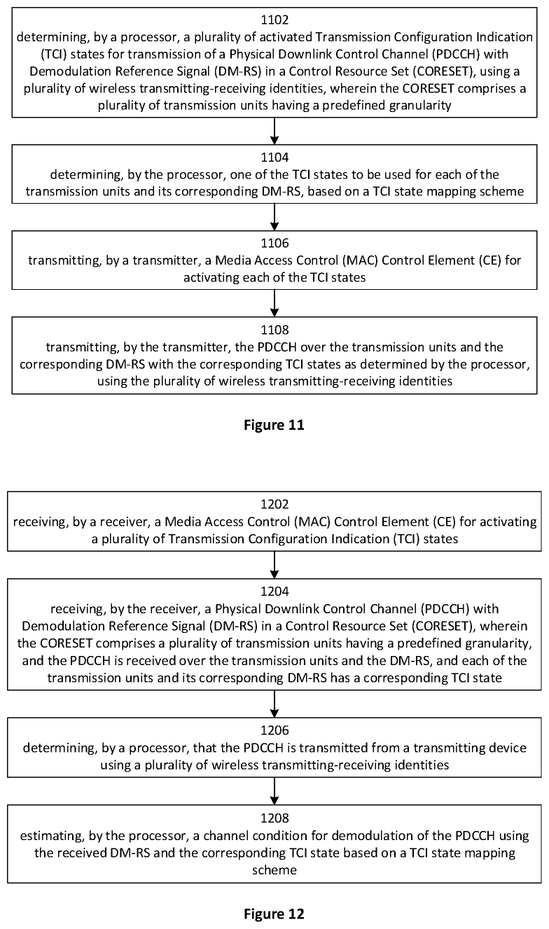

FIG. 12 is a flow chart illustrating steps of reception of enhanced DM-RS for enhanced PDCCH transmission with multiple beams from multiple TRPs by UE in accordance with some implementations of the present disclosure.

At step 1202, the receiver 214 of the UE 200 receives a Media Access Control (MAC) Control Element (CE) for activating a plurality of Transmission Configuration Indication (TCI) states.

At step 1204, the receiver 214 of the UE 200 further receives a Physical Downlink Control Channel (PDCCH) with Demodulation Reference Signal (DM-RS) in a Control Resource Set (CORESET), wherein the CORESET comprises a plurality of transmission units having a predefined granularity, and the PDCCH is received over the transmission units and the DM-RS, and each of the transmission units and its corresponding DM-RS has a corresponding TCI state.

The predefined granularity may be of Resource Element Group (REG), REG bundle, and/or Control Channel Element (CCE).

At step 1206, the processor 202 determines that the PDCCH is transmitted from a transmitting device 300 using a plurality of wireless transmitting-receiving identities, e.g. TRP 0 and TRP 1.

At step 1208, the processor 202 estimates a channel condition for demodulation of the PDCCH using the received DM-RS and the corresponding TCI state based on a TCI state mapping scheme.

In some embodiments, the processor 202 further determines a plurality of DM-RS ports for the PDCCH DM-RS based on a port mapping scheme. The port mapping scheme may be predefined between the transmitting device 300 and a receiving device 200 including the processor 202, such that the processor 202 is capable of implicitly derive a DM-RS port. The ports mapping scheme may comprise deriving a DM-RS port index for resources in a transmission unit, that is 2000 plus a remainder after division of an index of the transmission unit by a quantity of the activated TCI states.

Various embodiments and/or examples are disclosed to provide exemplary and explanatory information to enable a person of ordinary skill in the art to put the disclosure into practice. Features or components disclosed with reference to one embodiment or example are also applicable to all embodiments or examples unless specifically indicated otherwise.

Embodiments may be practiced in other specific forms. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

What is claimed is:

1. An apparatus comprising:
a processor configured to:
determine a plurality of activated Transmission Configuration Indication (TCI) states for transmission of a Physical Downlink Control Channel (PDCCH) with Demodulation Reference Signal (DM-RS) in a Control Resource Set (CORESET), using a plurality of wireless transmitting-receiving identities, wherein the CORESET comprises a plurality of transmission units having a predefined granularity; and
determine one of the TCI states to be used for each of the transmission units and its corresponding DM-RS, based on a TCI state mapping scheme; and
a transmitter configured to:
transmit a Media Access Control (MAC) Control Element (CE) for activating each of the TCI states; and
transmit the PDCCH over the transmission units and the corresponding DM-RS with the corresponding TCI states as determined by the processor, using the plurality of wireless transmitting-receiving identities.

2. The apparatus of claim 1, wherein the TCI state mapping scheme maps the activated TCI states to the transmission units according to indexes of the transmission units and a quantity of the activated TCI states.

3. The apparatus of claim 2, wherein the TCI state mapping scheme is predefined between the apparatus and a receiving device, such that the receiving device is configured to implicitly derive a TCI state for the DM-RS.

4. The apparatus of claim 2, wherein the TCI state mapping scheme comprises deriving an index of a TCI state for a transmission unit, that is a remainder after division of an index of the transmission unit by the quantity of the activated TCI states.

5. The apparatus of claim 1, wherein the processor is further configured to determine a plurality of DM-RS ports for the PDCCH DM-RS based on a port mapping scheme.

6. The apparatus of claim 5, wherein the port mapping scheme is predefined between the apparatus and a receiving device, such that the receiving device is capable of implicitly derive a DM-RS port.

7. The apparatus of claim 5, wherein the port mapping scheme comprises deriving a DM-RS port index for resources in a transmission unit, that is 2000 plus a remainder after division of an index of the transmission unit by a quantity of the activated TCI states.

8. The apparatus of claim 1, wherein the predefined granularity comprises one selected from a group comprising: Resource Element Group (REG), REG bundle, and Control Channel Element (CCE).

9. The apparatus of claim 1, wherein the processor is further configured to generate a plurality of PDCCH DM-RS scrambling IDs, and each PDCCH DM-RS scrambling ID is associated one TCI state or a DM-RS port, and is used to generate a PDCCH DM-RS sequence.

10. The apparatus of claim 1, wherein a plurality of Orthogonal Cover Codes (OCCs) are used for DM-RS ports, and each OCC is associated with one TCI state or DM-RS port.

11. An apparatus comprising:
a receiver configured to:
receive a Media Access Control (MAC) Control Element (CE) for activating a plurality of Transmission Configuration Indication (TCI) states; and
receive a Physical Downlink Control Channel (PDCCH) with Demodulation Reference Signal (DM-RS) in a Control Resource Set (CORESET), wherein the CORESET comprises a plurality of transmission units having a predefined granularity, and the PDCCH is received over the transmission units and the DM-RS, and each of the transmission units and its corresponding DM-RS has a corresponding TCI state; and
a processor configured to:
determine that the PDCCH is transmitted from a transmitting device using a plurality of wireless transmitting-receiving identities; and
estimate a channel condition for demodulation of the PDCCH using the received DM-RS and the corresponding TCI state based on a TCI state mapping scheme.

12. The apparatus of claim 11, wherein the TCI state mapping scheme maps the activated TCI states to the transmission units according to indexes of the transmission units and a quantity of the activated TCI states.

13. The apparatus of claim 12, wherein the TCI state mapping scheme is predefined between the apparatus and the transmitting device, such that the apparatus is capable of implicitly derive a TCI state for DM-RS.

14. The apparatus of claim 12, wherein the TCI state mapping scheme comprises deriving an index of a TCI state for a transmission unit, that is a remainder after division of an index of the transmission unit by the quantity of the activated TCI states.

15. The apparatus of claim 11, wherein the processor is further configured to determine a plurality of DM-RS ports for the PDCCH DM-RS based on a port mapping scheme.

16. The apparatus of claim 15, wherein the port mapping scheme is predefined between the apparatus and the transmitting device, such that the apparatus is configured to implicitly derive a DM-RS port.

17. The apparatus of claim 15, wherein the port mapping scheme comprises deriving a DM-RS port index for resources in a transmission unit, that is 2000 plus a remainder after division of an index of the transmission unit by a quantity of the activated TCI states.

18. The apparatus of claim 11, wherein the predefined granularity comprises one selected from a group comprising: Resource Element Group (REG), REG bundle, and Control Channel Element (CCE).

19. (canceled)

20. (canceled)

21. A method comprising:
determining, by a processor, a plurality of activated Transmission Configuration Indication (TCI) states for transmission of a Physical Downlink Control Channel (PDCCH) with Demodulation Reference Signal (DM-RS) in a Control Resource Set (CORESET), using a plurality of wireless transmitting-receiving identities, wherein the CORESET comprises a plurality of transmission units having a predefined granularity;
determining, by the processor, one of the TCI states to be used for each of the transmission units and its corresponding DM-RS, based on a TCI state mapping scheme;
transmitting, by a transmitter, a Media Access Control (MAC) Control Element (CE) for activating each of the TCI states; and
transmitting, by the transmitter, the PDCCH over the transmission units and the corresponding DM-RS with the corresponding TCI states as determined by the processor, using the plurality of wireless transmitting-receiving identities.

22. The method of claim 21, wherein the TCI state mapping scheme maps the activated TCI states to the transmission units according to indexes of the transmission units and a quantity of the activated TCI states.

23-40. (canceled)
